(19) United States
(12) Patent Application Publication
(10) Pub. No.: US 2007/0007328 A1
(43) Pub. Date: Jan. 11, 2007

(54) Methods and apparatus for recognizing and processing barcodes associated with mail

(76) Inventors: John J. Cole, Endwell, NY (US); Jon-Paul Faucher, Cortland, NY (US); Rafael Leopoldo Cabezas, Vestal, NY (US)

Correspondence Address: Lockheed Martin Corporation;c/o WOLF, GREENFIELD & SACKS, PC, FEDERAL RESERVE PLAZA, 600 ATLANTIC, BOSTON, MA, 02210-2206, US

(21) Appl. No.: 11/447,241

(22) Filed: Jun. 5, 2006

Related U.S. Application Data
(60) Provisional application No. 60/687,059, filed on Jun. 3, 2005.

(51) Int. Cl. G06F 17/00

(52) U.S. Cl. 235/375

(57) ABSTRACT

Embodiments of the invention relate to systems and methods of correlating data relating to an item of mail, such as barcode information, with the associated item of mail. This allows the item of mail to be sorted using the data relating to the item of mail. According to one embodiment of the invention, a method is provided for correlating an item of mail, subject to sorting by a mail sorter, with data, stored by a processing unit, relating to the item of mail. The method comprises acts of associating the item of mail with a first counter value, associating the data with a second counter value, and corresponding the first counter value with the second counter value to correlate the data with the item of mail.

### RELATED APPLICATIONS

This application claims priority under 35 U.S.C. § 119(e) to U.S. Provisional Application Ser. No. 60/687,059, entitled “Methods and Apparatus for Recognizing and Processing Barcodes Associated with Mail,” filed on Jun. 3, 2005, which is hereby incorporated by reference herein in its entirety.

### FIELD OF THE INVENTION

The invention relates generally to systems and methods used for the automated sorting of mail and, more specifically, to systems and methods used to correlate information relating to an item of mail with the associated item of mail.

### BACKGROUND

Barcodes are used by the United States Postal Service (USPS) to sort mail. Automated mail sorting systems can read barcodes on mail and sort mail based on final destination or other factors. This allows for efficient mail processing. Mail sorting systems currently used by the USPS have the ability to recognize and process conventional two-state barcodes, such as POSTNET barcodes. POSTNET barcodes encode zip code and delivery point code information using bars having two possible states, short or tall.

Barcodes for mail sorting have been developed that allow more information to be encoded relative to two-state barcodes. These barcodes are referred to as four-state barcodes because each bar of the barcode may have one of four variations. Specifically, each bar of a four-state barcode consists of a small bar that can have an ascender above it, a descender below it, or both. Two such barcodes are the Flat ID code sort (FICS) barcode and the Intelligent Mail (IM) barcode. FICS barcodes are barcodes that are applied to letters that do not have delivery information recognized by a mail sorter. A FICS barcode encoding sorting information will be printed on a label that is affixed to the letter. IM barcodes are used by mass mailers to identify mail with delivery information and other information (e.g., customer data and/or sender information).

Currently, mail sorting systems used by the USPS lack the ability to recognize and process four-state barcodes, such as FICS and IM barcodes. Accordingly, there is a need for system that can recognize and process four-state barcodes and interface with existing mail sorting systems used by the USPS.

### SUMMARY OF THE INVENTION

In view of the foregoing, there is a need for system that can recognize and process four-state barcodes and interface with existing mail sorting systems used by the USPS. So that the barcode data or other data generated by the system can be used by a mail sorting system, e.g., to sort an item of mail, the data must be correlated with the item of mail from which it was derived. Accordingly, aspects of the present invention relate to systems and methods for correlating data relating to an item of mail with the associated item of mail. The data may comprise information from a FICS barcode, information from an IM barcode, or other information relating to the item of mail.

One embodiment of the invention is directed to a method for correlating an item of mail, subject to sorting by a mail sorter, with data, stored by a processing unit, relating to the item of mail. The method comprises acts of associating the item of mail with a first counter value; associating the data with a second counter value; and corresponding the first counter value with the second counter value to correlate the data with the item of mail.

Another embodiment of the invention is directed to a system, comprising a mail sorter to sort an item of mail; a processing unit to generate data relating to the item of mail; a first counter adapted to generate a first counter value when the item of mail is at a predetermined position within the mail sorter; memory to store the data relating to the item of mail with a second counter value such that the data and the second counter value are linked in the memory; and means for corresponding the first counter value with the second counter value to correlate the data with the item of mail.

A further embodiment of the invention is directed to a processing unit, comprising an input to receive information for identifying an item of mail from a mail sorter; an input to receive an image of at least a portion of the item of mail from a camera; one or more processors to identify a barcode and generate sortable data relating to the barcode; means for correlating a unique identifier with the sortable data using the information; and an output for transmitting the unique identifier and the sortable data to the mail sorter.

### BRIEF DESCRIPTION OF THE DRAWINGS

FIG. 1 illustrates a block diagram of one embodiment of a system for processing and sorting mail;

FIG. 2 illustrates a block diagram of the barcode processing server 7 of FIG. 1 according to an embodiment of the invention;

FIG. 3 illustrates a block diagram of the barcode processing server 7 according to another embodiment of the invention; and

FIGS. 4a and 4b illustrate data structures for storing information within a shared memory of the barcode processing server 7.

### DETAILED DESCRIPTION

The United States Postal Service (USPS) delivers more than 206 billion pieces of mail each year to over 142 million delivery addresses. Automating the process of sorting mail improves the speed and accuracy with which mail is sorted. One system used by the USPS for automating the process of sorting mail is the Upgraded Flats Sorting Machine (UFSM 1000) manufactured by Lockheed Martin Corporation of Bethesda, Md. This system comprises a conveyor to transport mail and robotic handling to sort the mail based on POSTNET barcodes and/or address block information. The UFSM 1000 is used in connection with a camera and an object recognition system to acquire images of the mail and recognize and process POSTNET barcodes and address block information in the images. While the UFSM 1000 is able to recognize and process POSTNET barcodes, it cannot recognize and process four-state barcodes.

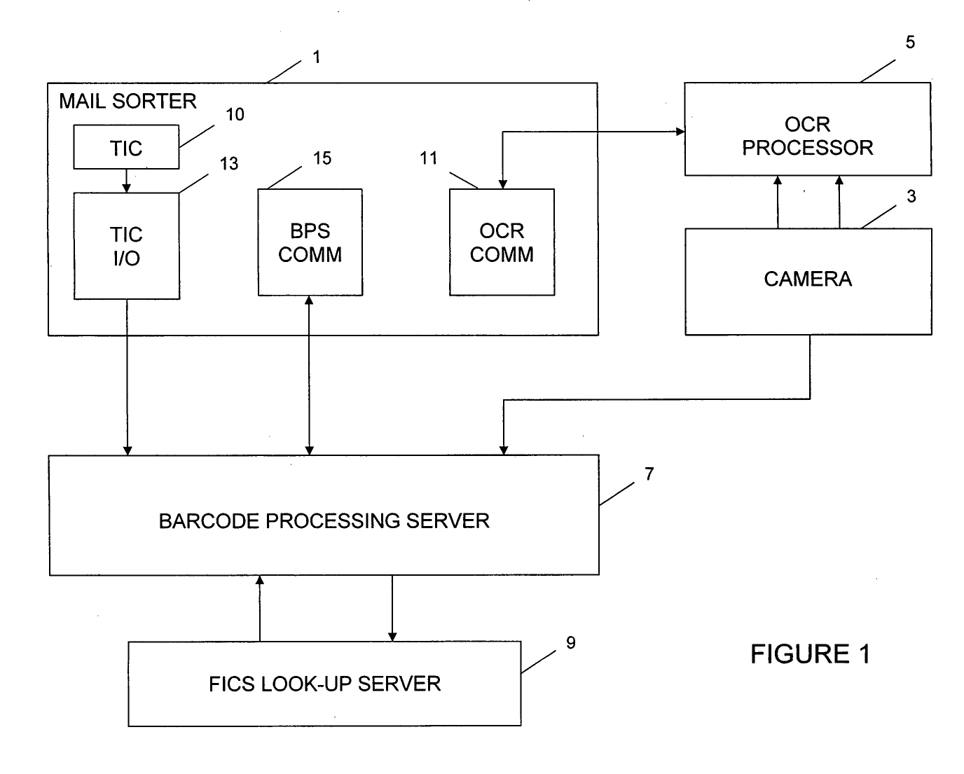

FIG. 1 illustrates one embodiment of a system for processing and sorting mail that is capable of recognizing and processing both conventional two-state barcodes and four-state barcodes. The system comprises a mail sorter 1, which may be the UFSM 1000 system described above, a camera 3 for acquiring images of the mail passing through the mail sorter 1, an optical character recognition (OCR) processor 5 for recognizing and processing address information and conventional two-state barcodes, a FICS look-up server 9 for processing flat ID code sort (FICS) barcodes, a barcode processing server 7 for recognizing four-state barcodes, processing Intelligent Mail (IM) barcodes, and serving as an interface between the mail sorter 1 and the FICS look-up server 9. Each of mail sorter 1, camera 3, OCR processor 5, FICS look-up server 9, and barcode processing server 7 may be a separate component linked to the other components via an external data link. Thus, one or more of mail sorter 1, camera 3, OCR processor 5, FICS look-up server 9, and barcode processing server 7 may be remotely located from the other components. Alternatively, one or more of the components may be integrated to form a unitary component.

As an item of mail passes through mail sorter 1, it is imaged by camera 3. According to one exemplary implementation, camera 3 is a line scan camera, model number AV 1520, manufactured by Accu-Sort Systems, Inc. of Telford, Pa. However, other cameras capable of capturing grayscale and/or binary images of mail may alternatively be used. Camera 3 comprises three ports. Two of these ports are used to couple the camera 3 to OCR processor 5, and the other is used to couple the camera to barcode processing server 7. As will be discussed, OCR processor 5 is used to recognize and process address block and two-state barcode information. Barcode processing server 7, in connection with FICS look-up server 9, is used to recognize and process FICS and IM four-state barcodes.

Two-state barcode and address block information is processed by the system of FIG. 1 in a conventional manner. Specifically, camera 3 transmits images acquired to OCR processor 5 so that address block and two-state barcode information included in the images may be recognized and processed. In the exemplary system of FIG. 1, OCR processor 5 is a Flats Mail Optical Character Recognition (FMOCR) system manufactured by Siemens AG of Munich, Germany. OCR processor 5 decodes the barcode and/or converts the image of the address block to a readable format. This processed information is transmitted to OCR communication interface 11 within mail sorter 1. Mail sorter 1 then sorts the mail according to the received information.

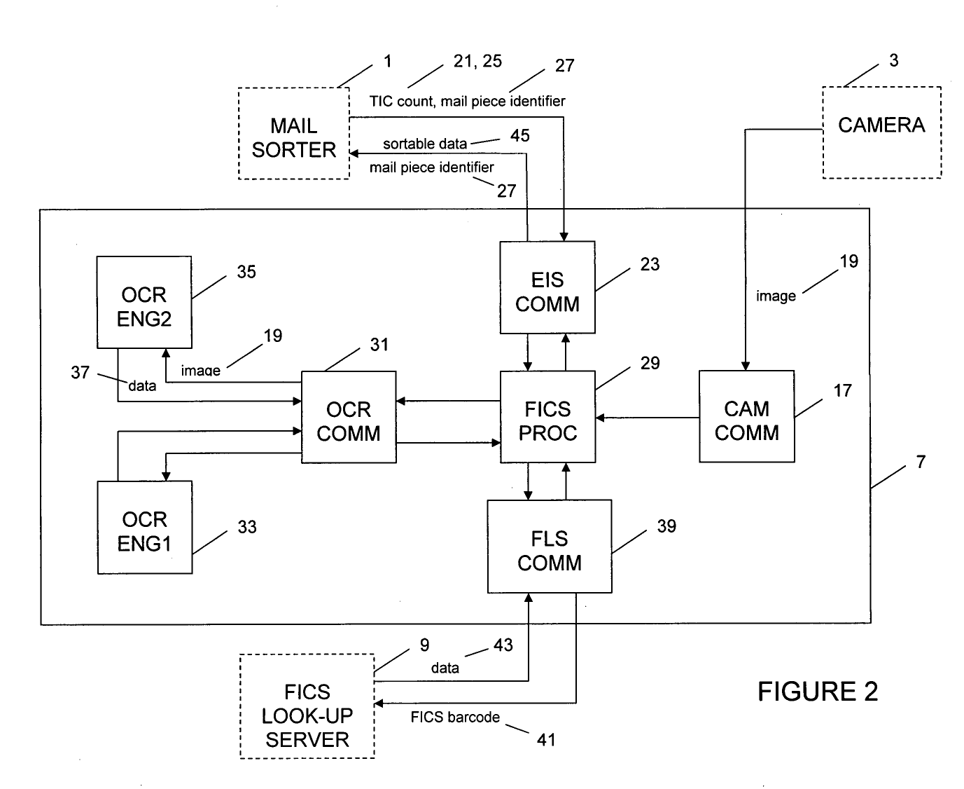

Four-state barcode information is processed by the system of FIG. 1 using the barcode processing server 7 and various interfaces provided to FICS look-up server 9, mail sorter 1 and camera 3. Barcode processing server 7 interfaces with a Time Interval Counter (TIC) I/O 13 and a barcode processing server communication interface 15 of mail sorter 1. These interfaces, as well as the operations and functions of barcode processing server 7, will be described in detail in connection with FIG. 2.

FIG. 2 illustrates a block diagram of barcode processing server 7 and the interfaces of the barcode processing server 7 to the mail sorter 1, camera 3, and FICS look-up server 9 previously discussed. The processing of mail having four-state barcodes will now be discussed. As an item of mail passes through mail sorter 1, its location is tracked by a Time Interval Counter (TIC) 10 coupled to TIC I/O interface 13 shown within the mail sorter 1 of FIG. 1. The TIC 10 generates a count that is incremented as the conveyor of mail sorter 1 is moved, and thus may be correlated with a location of the item of mail within mail sorter 1. Thus, the TIC 10 may be used to track to movement of mail through the mail sorter 1 so that the location of a given item of mail may be known as it passes through the mail sorter 1. One suitable TIC that may be used is counter/timer board, model number PCI-CTR05, manufactured by Measurement Computing Corporation of Middleboro, Mass.

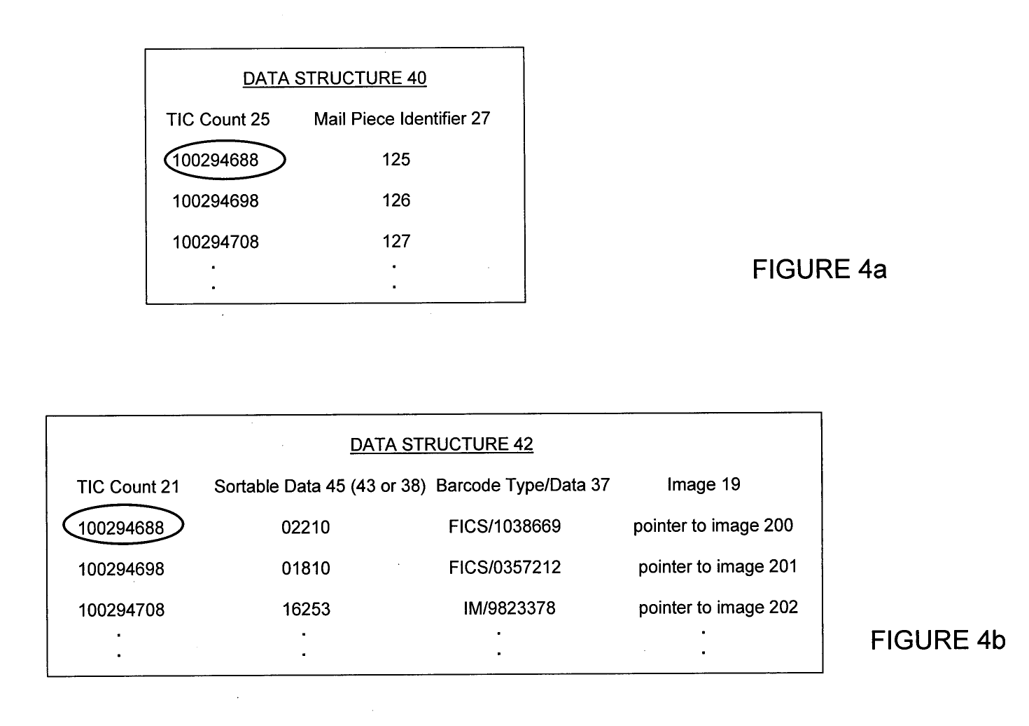

After an item of mail enters mail sorter 1 and is imaged by camera 3, the image 19 is transmitted to a camera communication interface 17 within barcode processing server 7 and is stored in shared memory. The shared memory may be located, for example, within the barcode processing server 7. Image 19 may be stored in shared memory with a TIC count 21 requested from mail sorter 1. For example, FIG. 4b shows an exemplary data structure 42, comprising TIC count 21 and a pointer to image 19, that may be stored in shared memory. TIC count 21 represents a count of the TIC 10 at the time when the image 19 was acquired by camera 3, or at another predetermined time. TIC count 21 is transmitted from the TIC 10 via a TIC I/O interface 13 (FIG. 1) of mail sorter 1. TIC count 21 is received at the Enhanced Induction Station (EIS) communication interface 23 of barcode processing server 7, and then stored in shared memory with image 19 (or a pointer thereto) as described above. At the same time that TIC count 21 is requested by barcode processing server 7, a TIC count 25 is also read by mail sorter 1 from the TIC 10. Mail sorter 1 associates TIC count 25 with a mail piece identifier 27, which is a unique identifier assigned to an item of mail. TIC count 25 and mail piece identifier 27 are also transmitted to EIS communication interface 23 of barcode processing server 7 via TIC I/O interface 13 (FIG. 1) of mail sorter 1 and stored together in shared memory. For example, FIG. 4a shows an exemplary data structure 40, comprising TIC count 25 and mail piece identifier 27, that may be stored in shared memory. As will be discussed herein, TIC counts 21 and 25 and mail piece identifier 27 are used to associate barcode data processed by barcode processing server 7 with a particular item of mail being handled by mail sorter 1.

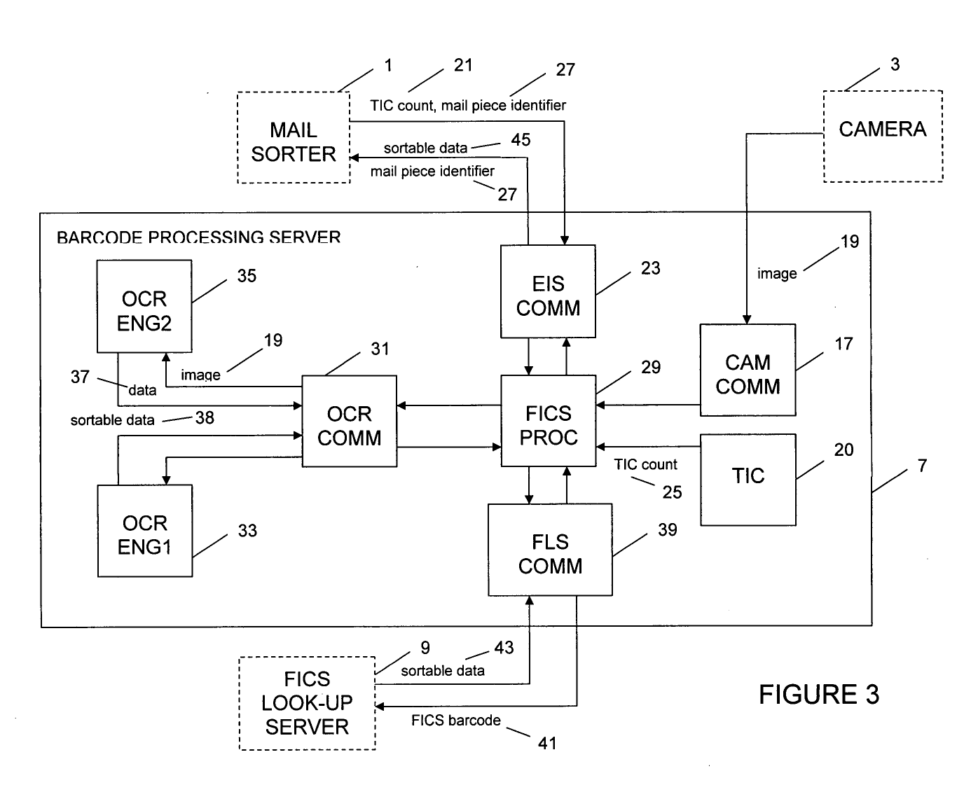

Although TIC count 25 is described as being generated by the TIC 10 of mail sorter 1 and being transmitted to the barcode processing server 7, TIC count 25 may alternatively be generated by a second TIC associated with the barcode processing server. For example, as shown in FIG. 3, barcode processing server 7 may comprise a TIC 20 that generates TIC count 25. The TIC 20 may be synchronized with the TIC 10 (FIG. 1) such that the TIC 20 increments at the same rate and at the same times as TIC 10. A data connection (e.g., a wireless connection or an Ethernet connection) may be provided between TIC 10 and TIC 20 to transmit synchronization signals. Once generated, TIC count 25 is transmitted to FICS processor 29 and treated in the same manner as described in connection with FIG. 2.

Referring again to FIG. 2, when image 19 is received by camera communication interface 17, it is transmitted to optical character recognition (OCR) communication interface 31 by a processor 29. OCR communication interface 31 will in turn transmit image 19 to one of OCR engines 33 and 35. OCR engines 33 and 35 may have identical functionality, and thus allow parallel processing of images and other data. OCR communication interface 21 selects one of OCR engines 33 and 35 based on which OCR engine is available, and transmits image 19 to that OCR engine. In the example of FIG. 2, image 19 is transmitted to OCR engine 35. Each of the OCR engines 33 and 35 may use Lockheed Martin Symbol Recognition (LMSR) software to process a received image and return all barcode data identified in the image. Specifically, the LMSR software returns the type of barcode and the data of the barcode (i.e., all digits for the barcode) for each barcode identified. The barcode type and barcode data corresponding to image 19, collectively data 37, is stored in shared memory with image 19 and TIC count 21, as shown in FIG. 4b. OCR engine 35 then notifies OCR communication interface 31 that the processing of image 19 is complete and that the results of such processing have been stored in memory.

The OCR communication interface 31 will then determine, based on data 37, what type of barcode(s) were contained within image 19. If the OCR communication interface 31 determines that data 37 comprises a FICS barcode 41, a message is transmitted to processor 29, following which processor 29 notifies FICS look-up server interface 39 that a FICS barcode is ready to be processed. FICS look-up server (FLS) interface 39 transmits the FICS barcode 41 to FICS look-up server 9. FICS look-up server 9 may be a REMLOC server manufactured by Northrop Grumman Corporation of Los Angeles, Calif., or another processor that may be used to perform a lookup to determine sortable data relating to the FICS barcode 41. For example, FICS look-up server 9 may store zip code information associated with a particular barcode. Sortable data 43 determined by FICS look-up server 9 based on the FICS barcode 41 is transmitted back to FICS look-up server interface 39 and stored in shared memory with the corresponding image 19.

Returning again to the data 37 generated by OCR engine 35, if the OCR communication interface 31 determines that data 37 comprises an IM barcode, one of OCR engines 35 and 37 performs a lookup to determine sortable data 38 relating to the IM barcode. Sortable data 38 determined by the OCR engine based on the IM barcode is stored in shared memory with the corresponding image 19.

Once the four-state bar codes have been recognized by barcode processing server 7, processed by the barcode processing server 7 and/or FICS look-up server 9, the resulting sortable data 45, which may correspond to sortable data 43 returned by FICS look-up server 9 or sortable data 38 returned by OCR engines 33 or 35, is stored in shared memory. For example, sortable data 45 may be stored as part of data structure 42 previously described in connection with FIG. 4b. After sortable data 45 has been stored, the results are ready to be returned to mail sorter 1. If FICS look-up server 9 has completed processing a FICS barcode, EIS communication interface 23 will be notified that sortable data is ready to be returned to mail sorter 1. Similarly, if OCR engine 33 or 35 has completed processing an IM barcode, OCR communication interface 31 notifies EIS communication interface 23 that sortable data is ready to be returned to mail sorter 1.

EIS communication interface 23 matches TIC count 21, which is stored in memory with the sortable data 45 as shown in data structure 42 of FIG. 4b, with TIC count 25, which is stored in memory with mail piece identifier 27 as shown in data structure 40 of FIG. 4a, by comparing the values of the TIC counts. For example, the TIC counts 25 and 21 encircled by an oval in FIGS. 4a and 4b have corresponding values; thus, the mailpiece identifier 27 associated with the encircled TIC count 25 corresponds with the sortable data 45 associated with the encircled TIC count 21. In this manner, EIS communication interface 23 is able to correlate sortable data 45 with a corresponding mail piece identifier 27. Sortable data 45 and its related mail piece identifier 27 are then returned to mail sorter 1. Mail sorter 1 uses mail piece identifier 27 to determine a corresponding item of mail being processed, and may use sortable data 45 to determine how the item of mail should be sorted. For example, mail sorter 1 may use the sortable data 45 to sort the item of mail by zip code.

It should be appreciated that data structures 40 and 42 are one example of how TIC count 21, TIC count 25, mailpiece identifier 27, data 45, and/or image 19 may be stored in memory, however many implementations are possible. For example, a single data structure with all of the data in data structures 40 and 42 may alternatively be used. In addition, other formats for storing data, other than a data structure, may alternatively be used.

It should be appreciated that the system shown in FIG. 1 represents one exemplary implementation of a system for performing the various functions described herein, however other configurations are possible. The components of the system are shown for illustrative purposes, and need not be limited to the specific components shown. For example, while mail sorter 1 is the UFSM 1000 in the embodiment of FIG. 1, other mail sorters may be used. Camera 3 also may be implemented using any suitable line scan camera or other device or apparatus capable of imaging address and barcode information on mail. FICS look-up server 9 may or may not be included in the overall system, depending on whether it is desired that the system be capable of processing FICS barcodes. In addition, barcode processing server 7 may be implemented as one or more computing systems and is not limited to the particular configuration shown. Further, although the system has been described in the context of processing barcodes, the invention is not so limited. The principles described herein for correlating data with an item of mail may also be applied to other information relating to items of mail (e.g., recipient information or postage information).

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for correlating an item of mail, subject to sorting by a mail sorter, with data, stored by a processing unit, relating to the item of mail, the method comprising acts of:
associating the item of mail with a first counter value;
associating the data with a second counter value; and
corresponding the first counter value with the second counter value to correlate the data with the item of mail.

2. The method of claim 1, wherein:
the mail sorter comprises a conveyor; and
the first counter value is generated by a first counter associated with the mail sorter in response to movement of the conveyor.

3. The method of claim 1, wherein the first counter value is generated by a first counter associated with the mail sorter and the second counter value is generated by a second counter associated with the processing unit, and wherein the method further comprises an act of:
synchronizing the first counter with the second counter.

4. The method of claim 3, wherein the second counter is incremented only when the first counter is incremented.

5. The method of claim 1, further comprising an act of:
corresponding one of the first or second counter values with a mail piece identifier to correlate the data with the mail piece identifier.

6. The method of claim 1, wherein the data comprises data usable by the mail sorter to sort the item of mail.

7. The method of claim 1, wherein the mail sorter and the processing unit are functionally coupled via at least one data link that is external to each of the mail sorter and the processing unit.

8. The method of claim 1, further comprising an act of:
transmitting the data from the processing unit to the mail sorter together with an indication of the item of mail.

9. The method of claim 8, further comprising an act of:
using the data at the mail sorter to sort the item of mail.

10. The method of claim 1, wherein the data comprises an image of a barcode, and further comprising an act of:
using the processing unit, decoding the barcode.

11. A system, comprising:
a mail sorter to sort an item of mail;
a processing unit to generate data relating to the item of mail;
a first counter adapted to generate a first counter value when the item of mail is at a predetermined position within the mail sorter;
memory to store the data relating to the item of mail with a second counter value such that the data and the second counter value are linked in the memory; and
means for corresponding the first counter value with the second counter value to correlate the data with the item of mail.

12. The system of claim 11, wherein:
the mail sorter comprises a conveyor; and
the first counter value is generated by a first counter associated with the mail sorter in response to movement of the conveyor.

13. The system of claim 11, wherein the second counter value is generated by a second counter associated with the processing unit, and wherein the first and second counters are synchronized.

14. The system of claim 13, wherein the second counter is adapted to be incremented only when the first counter is incremented.

15. The system of claim 11, wherein the data generated by the processing unit comprises data usable by the mail sorter to sort the item of mail.

16. The system of claim 11, further comprising a data link, external to each of the mail sorter and the processing unit, that functionally couples the mail sorter and the processing unit.

17. The system of claim 11, further comprising a camera to provide an image of at least a portion of the item of mail, wherein the processing unit is adapted to generate the data relating to the item of mail based at least in part on the image.

18. The system of claim 17, wherein the image comprises an image of a barcode, and wherein the processing unit is adapted to generate the data relating to the item of mail based at least in part on the barcode.

19. The system of claim 11, wherein the mail sorter is adapted to sort the item of mail at least in part using the data generated by the processing unit.

20. A processing unit, comprising:
an input to receive information for identifying an item of mail from a mail sorter;
an input to receive an image of at least a portion of the item of mail from a camera;
one or more processors to identify a barcode and generate sortable data relating to the barcode;
means for correlating a mail piece identifier with the sortable data using the information; and
an output for transmitting the mail piece identifier and the sortable data to the mail sorter.

21. The processing unit of claim 20, wherein the one or more processors are adapted to decode a four-state barcode.
